(19) United States
(12) Patent Application Publication
(10) Pub. No.: US 2015/0322315 A1
(43) Pub. Date: Nov. 12, 2015

(54) CURABLE COMPOSITIONS

(71) Applicant: BLUE CUBE IP LLC, Midland, MI (US)

(72) Inventor: Maurice J Marks, Lake Jackson, TX (US)

(21) Appl. No.: 14/650,985

(22) PCT Filed: Dec. 14, 2013
(86) PCT No.: PCT/US2013/073256

§ 371 Date: Jun. 10, 2015

Related U.S. Application Data
(60) Provisional application No. 61/737,333, filed on Dec. 14, 2012.

(51) Int. Cl. C09J 179/02; C08K 5/00; C09D 179/02; C08K 3/00; C08J 5/24

(52) U.S. Cl. CPC C09J 179/02; C08K 3/0033; C08J 5/24; C09D 179/02; C08K 5/0008; C08J 2379/02

(57) ABSTRACT

A curable polyfunctional terminal styrenic composition comprising a reaction product of: (a) at least one divinylarene monoxide compound, and (b) at least one polyfunctional epoxide coupling compound to form a curable polyfunctional terminal styrenic composition; a thermoset prepared from the above curable composition; and a process for preparing the curable composition and the thermoset.

### FIELD

The present invention is related to a curable composition based on a reaction product of a divinylarene monoxide reacted with a polyfunctional epoxide coupling compound to form a novel curable polyfunctional terminal styrenic composition. The curable compositions can be cured with heat and/or free radical initiators to form new cured compositions.

### BACKGROUND

U.S. Pat. No. 2,768,182 discloses preparing divinylbenzene monoxide (DVBMO); and discloses that DVBMO may be used to prepare polymers and epoxide derivatives such as by reacting DVBMO with mono- or dicarboxylic acids, alcohols, amines, and thiols.

Nippon Kagaku Zasshi (1965), 86(8), 860-3 (Chem. Abstracts 1966:482689) discloses polymerizing DVBMO to form pendant epoxide-functional vinyl polymers and copolymers.

U.S. Pat. No. 3,728,320 discloses polymerizing DVBMO with various epoxides to form copolyethers bearing pendant styrenic groups.

EP 540027 discloses copolymerizing DVBMO and a polybasic compound to form a copolymer having pendant (side chain) styrenic (vinyl) groups.

Heretofore, nothing in the prior teaches both (1) the use of a polyfunctional epoxide coupling compound having a functionality greater than or equal to 2 to produce a non-epoxide functional polyfunctional styrenic compound bearing terminal styrenic groups; and (2) the curing of the above polyfunctional styrenic compound with heat alone, or with heat in combination with other additives such as a free radical initiator.

### SUMMARY

One embodiment of the present invention is directed to a novel curable composition of matter including the reaction product of (a) at least one divinylarene monoxide compound and (b) at least one polyfunctional epoxide coupling compound.

Another embodiment of the present invention is directed to a thermoset prepared from the above curable composition.

Still other embodiments of the present invention include a process for preparing the above curable composition and a process for preparing a thermoset product from the above curable composition wherein the thermoset can be useful in various applications such as for producing a composite.

Some of the advantages of the curable composition of the present invention include its ability to be cured with applied heat, with added curing initiators, or both, and its compatibility with other vinyl monomers and formulation additives.

Some of the advantages of the cured composition of the present invention include its resistance to heat, organic solvents, or both

### DETAILED DESCRIPTION

A broad embodiment of the present invention is directed to providing a curable resin composition of matter including the reaction product of (a) at least one divinylarene monoxide compound and (b) at least one polyfunctional epoxide coupling compound. Other optional additives known to the skilled artisan can be included in the curable composition such as for example a curing catalyst and other additives for various enduse applications.

The curable composition of the present invention includes a reaction product of (a) at least one divinylarene monoxide (DVAMO) compound and (b) a polyfunctional epoxide coupling (herein abbreviated as “PEC”) compound, wherein the resulting reaction product comprises a curable polyfunctional terminal styrenic (herein abbreviated as “PFTS”) composition.

The DVAMO useful in the present invention may be any substituted or unsubstituted arene having one bound epoxide and vinyl radical in any ring position; or mixtures of two or more DVAMO. The arene portion of the divinylarene monoxide may consist of benzene, substituted benzenes, (substituted) ring-annulated benzenes or homologously bonded (substituted) benzenes, or mixtures thereof. The divinylbenzene portion of the divinylarene monoxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthalene, tetrahydronaphthalene, and the like. Homologously bonded (substituted) benzenes may consist of biphenyl, diphenylether, and the like.

For example, the DVAMO may include divinylbenzene monoxide (DVBMO), divinylnaphthalene monoxide, divinylbiphenyl monoxide, divinyldiphenylether monoxide, and mixtures thereof.

The PEC compound useful for preparing the PFTS composition of the present invention includes for example a monomeric, oligomeric, or polymeric compound bearing 2 or more functional groups which is capable of coupling with an arene-bound epoxide. For example, the PEC compound can be a polymeric compound bearing groups such as amines, carboxylic acids, phenols, alcohols, or thiol groups, or mixtures thereof.

For example, the PEC compound may include for example, polyamine, polyamide, polyaminoamide, dicyandiamide, polyphenol, polymeric thiol, polycarboxylic acid and anhydride, and any combination thereof or the like. Other specific examples of PEC compounds include phenol novolacs, bisphenol-A novolacs, phenol novolac of dicyclopentadiene, cresol novolac, diaminodiphenylsulfone, styrene-maleic acid anhydride (SMA) copolymers; and any combination thereof.

Articles based on the cured composition of the present invention may be exposed to hydrolytic conditions, such as by exposure to aqueous acids or bases. Therefore, the preferred PEC compounds of the present invention do not form ester bonds upon coupling with a DVAMO. Examples of the PEC compounds useful in the present invention can include amines and amino or amido containing resins; polymeric thiols; phenolics; or mixtures thereof.

As described below, in one preferred embodiment the PFTS composition of the present invention is soluble in a solvent. To minimize polymerization of the vinyl groups of the DVAMO and the PFTS, it is beneficial to conduct the coupling reaction with the PEC compounds which react at a relatively low temperature. Therefore, in another more preferred embodiment, the PEC compounds can include for example amines and amino or amido containing resins, polymeric thiols, or mixtures thereof.

In preparing the PFTS composition of the present invention, in addition to the DVAMO described above, the reaction mixture may include at least one epoxy resin. Epoxy resins are those compounds containing at least one vicinal epoxy group. The epoxy resin may be saturated or unsaturated, aliphatic, cycloaliphatic, aromatic or heterocyclic and may be substituted. The epoxy resin may also be monomeric or polymeric. The epoxy resin useful in the present invention may be selected from any known epoxy resins in the art. An extensive enumeration of epoxy resins useful in the present invention is found in Lee, H. and Neville, K., “Handbook of Epoxy Resins,” McGraw-Hill Book Company, New York, 1967, Chapter 2, pages 257-307; incorporated herein by reference.

The epoxy resins, used in embodiments disclosed herein for an optional component of the present invention, may vary and include conventional and commercially available epoxy resins, which may be used alone or in combinations of two or more. In choosing epoxy resins for compositions disclosed herein, consideration should not only be given to properties of the final product, but also to viscosity and other properties that may influence the processing of the resin composition.

Particularly suitable epoxy resins known to the skilled worker are based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known to the skilled worker include reaction products of epichlorohydrin with o-cresol and, respectively, phenol novolacs. It is also possible to use a mixture of two or more epoxy resins.

Other epoxy resins useful in the present invention may be selected from commercially available products such as commercially available liquid epoxy resins (LER) and commercially available solid epoxy resins (SER). For example, D.E.R. 331, D.E.R.332, D.E.R. 334, D.E.R. 580, D.E.N. 431, D.E.N. 438, D.E.R. 736, or D.E.R. 732 available from The Dow Chemical Company may be used. As an illustration of the present invention, the epoxy resin component (a) may be a liquid epoxy resin, D.E.R.® 383 (DGEBPA) having an epoxide equivalent weight of 175-185, a viscosity of 9.5 Pa-s and a density of 1.16 g/cc. Other commercial epoxy resins that can be used for the epoxy resin component can be D.E.R. 330, D.E.R. 354, or D.E.R. 332. Other epoxy resins useful in the present invention may include SERs such as those designated as DER 661 to DER 669, preferably DER 664 commercially available from The Dow Chemical Company. Other epoxy resins useful in the present invention also may include DER 542 and other brominated epoxy resins.

Other suitable epoxy resins useful in the present invention are disclosed, for example, in U.S. Pat. Nos. 3,018,262; 7,163,973; 6,887,574; 6,632,893; 6,242,083; 7,037,958; 6,572,971; 6,153,719; and 5,405,688; PCT Publication WO 2006/052727; and U.S. Patent Application Publication Nos. 20060293172; 20050171237; and 2007/0221890 A1; each of which is hereby incorporated herein by reference.

In a preferred embodiment, the epoxy resin useful in preparing the PFTS composition of the present invention comprises any aromatic or aliphatic glycidyl ether or glycidyl amine or a cycloaliphatic epoxy resin.

In another preferred embodiment, the epoxy resin useful in preparing the PFTS composition of the present invention comprises a divinylarene dioxide, particularly divinylbenzene dioxide.

In preparing the PFTS composition of the present invention, in addition to the PEC compound described above, the reaction mixture may include at least one monofunctional epoxide coupling compound. The monofunctional epoxide compounds of the present invention include for example a monomeric, oligomeric, or polymeric compound bearing only 1 functional group which is capable of coupling with an arene-bound epoxide. For example, the monofunctional epoxide coupling compound can be a polymeric compound bearing groups such as a secondary amine, a monocarboxylic acid, a monophenol, a monoalcohol, a monothiol group, or mixtures thereof.

The curable PFTS composition of the present invention is prepared by the reaction of (a) at least one divinylarene monoxide compound and (b) at least one PEC compound, including any of the above optional reactive components, in any amounts such that the number average functionality (Fₙ) of the reaction mixture is greater than 1.0. The number average functionality (Fₙ) is calculated by equation 1, where nᵢ is the mole fraction and fᵢ is the functionality of the epoxide or epoxide coupling compound reactive group of the reactive components of the reaction mixture. When Fₙ is greater than 1.0 the reaction product has at complete conversion of the epoxide and epoxide coupling compound functional groups greater than 1 terminal styrenic groups on average, comprises a compound having at least 2 terminal styrenic groups, and is thereby curable upon their polymerization. When Fₙ is 1.0 or less the reaction product has at complete conversion of the epoxide and epoxide coupling compound functional groups less than or equal to 1 terminal styrenic groups and is thereby not curable upon their polymerization. In one embodiment Fₙ may range generally from greater than 1.0 to about 1000, from greater than 1.0 to about 100 in another embodiment, and from greater than 1.0 to about 10 in still another embodiment.

Fₙ=Σnᵢfᵢ>1.0 (Equation 1)

In another embodiment, the curable PFTS composition of the present invention is prepared by the reaction of (a) at least one divinylarene monoxide compound and (b) at least one PEC compound, including any of the above optional reactive components, in any amounts such that the weight average functionality (F_{w}) of the reaction mixture is less than or equal to 2.0. The weight average functionality (F_{w}) is calculated from equation 2, where wᵢ is the weight fraction and fᵢ is the functionality of the epoxide or epoxide coupling compound reactive group of the reactive components of the reaction mixture. At F_{w}≦2.0 the reaction product is soluble in a solvent at complete conversion of the epoxide and epoxide coupling compound functional groups. The curable compositions of the present invention do not require complete conversion of the epoxide and epoxide coupling compound functional groups, but those that do have better storage stability. The curable compositions of the present invention do not require solubility in a solvent, but those that are soluble are easier to formulate with optional curing initiators and other optional components. In one embodiment F_{w} may range generally from about 0.001 to 2.0, from about 0.01 to 2.0 in another embodiment, and from 0.02 to 2.0 in still another embodiment.

F_{w}=Σwᵢfᵢ≦2.0 (Equation 2)

In yet another embodiment the curable PFTS compositions of the present invention can be prepared in the presence of at least one coupling catalyst. The coupling catalysts of the present invention are those known in the art to catalyze the coupling of epoxides and epoxide coupling compounds. The optional coupling catalyst useful in the present invention may include catalysts well known in the art, such as for example, catalyst compounds containing amine, phosphine, heterocyclic nitrogen, ammonium, phosphonium, arsonium, sulfonium moieties, and any combination thereof. Some non-limiting examples of the catalyst of the present invention may include, for example, ethyltriphenylphosphonium; benzyltrimethylammonium chloride; heterocyclic nitrogen-containing catalysts described in U.S. Pat. No. 4,925,901, incorporated herein by reference; imidazoles; triethylamine; and any combination thereof.

The concentration of the optional coupling catalyst used in the present invention may range generally from 0 wt % to about 20 wt %, preferably from about 0.01 wt % to about 10 wt %, more preferably from about 0.1 wt % to about 5 wt %, and most preferably from about 0.2 wt % to about 2 wt %.

In still another embodiment of the present invention, one or more optional solvents well known in the art may be used in the curable PFTS composition. For example, aromatics such as xylene, ketones such as methyl ether ketone, and alcohols such as 1-methoxy-2-propanol; and mixtures thereof, may be used in the present invention. In yet another embodiment of the present invention, the curable PFTS composition is soluble in one or more solvents.

The concentration of the optional solvent used in the present invention may range generally from 0 wt % to about 90 wt %, preferably from about 1 wt % to about 80 wt %, more preferably from about 10 wt % to about 65 wt %, and most preferably from about 20 wt % to about 50 wt %.

In general, the steps of preparing the PFTS composition of the present invention comprise contacting a DVAMO (an epoxide compound) and a PEC compound, optionally in the presence of a coupling catalyst, and allowing the epoxide compound and the PEC compound to react. The final reaction product prepared by the above reaction process comprises a PFTS composition.

The process for preparing the PFTS composition of the present invention includes admixing (a) DVAMO and (b) a PEC compound, optionally in the presence of (c) a coupling catalyst, or other optional ingredients as needed. For example, the preparation of the PFTS composition of the present invention is achieved by blending, in known mixing equipment, the DVAMO compound, the coupling compound, and optionally any other desirable additives. Any of the optional additives may be added to the composition during the mixing or prior to the mixing to form the reaction mixture.

All the compounds of the PFTS composition are typically mixed and dispersed at a temperature enabling the preparation of an effective reaction product having the desired balance of properties for a particular application. For example, the temperature during the mixing of all components may be generally from about 0° C. to about 200° C. in one embodiment, and from about 20° C. to about 180° C. in another embodiment. Lower mixing temperatures help to minimize reaction of the DVAMO and PEC compound in the reaction mixture prior to complete mixing of all of the reaction components.

In preparing the PFTS composition an equivalent ratio of epoxide to epoxide coupling groups of from 0.01 to 100 may be used in one embodiment, from about 0.05 to about 20 may be used in another embodiment, and from 0.1 to about 10 may be used in still another embodiment.

The temperature employed for the reaction conditions can be for example, a temperature at least about 0° C. in one embodiment, at least 20° C. in another embodiment, and at least 40° C. in still another embodiment. The temperature employed for the reaction conditions can be for example, a temperature not more than about 200° C. in one embodiment, not more than 180° C. in another embodiment, and not more than 160° C. in still another embodiment. In yet another embodiment, the temperature employed for the reaction conditions can be for example, a temperature from at least about 0° C. to not more than about 200° C.

The reaction time for producing the PFTS composition can be over a period of from about 0.01 day to about 1 day in one embodiment, a period of from about 0.1 day to about 0.9 day in another embodiment, and a period of from about 0.2 day to about 0.8 day in still another embodiment.

The preparation of the PFTS composition of the present invention, and/or any of the steps thereof, may be a batch or a continuous process. The mixing equipment used in the process may be any vessel and ancillary equipment well known to those skilled in the art.

The PFTS composition described above may be a liquid, a semi-solid, or a solid. Preferably, the PFTS composition described above is made using a reaction mixture having F_{w}≦2.0 such that the composition is at complete epoxide and epoxide coupling compound functional group conversion soluble in a solvent; and, if a solid or a semi-solid, the PFTS composition can be melted to form a liquid.

In one broad embodiment of the present invention, a curable resin composition of matter can comprise the PFTS composition described above with or without reactive or non-reactive additives, agents or compounds blended with the PFTS composition. Therefore, in one embodiment, the only required component to prepare the curable composition of the present invention is the at least one PFTS composition.

As an illustrative embodiment, wherein the PFTS composition is used alone, the concentration of the at least one PFTS composition in the curable composition of the present invention is from about 1 wt % to 100 wt %, preferably from about 10 wt % to 100 wt %, and more preferably from about 20 wt % to 100 wt %.

In another embodiment of the present invention, one or more optional reactive additives may be combined or blended with the PFTS composition to form a curable composition. For example, the optional reactive additives useful in the present invention may comprise compounds having at least one vinyl group which can copolymerize with the PFTS composition. For example, the optional reactive additives may include styrenics such as styrene and divinylbenzene; (meth)acrylates such as butyl acrylate, methyl methacrylate, ethylene glycol diacrylate, and trimethylolpropane triacrylate; and mixtures thereof.

In still another embodiment of the present invention, the curable composition can be prepared including the PFTS reaction product composition described above with other additives, agents or compounds blended with the PFTS composition. Therefore, in this embodiment, the curable composition of the present invention includes (a) at least one PFTS composition; and (b) at least one other desired optional compound.

Any optional additive known to the skilled artisan can be included in the curable composition such as for example additives for various enduse applications. In general, the various optional compounds that can be added to the curable composition of the present invention described above includes additives, agents, or compounds that are normally used by those skilled in the art for preparing curable resin formulations or compositions and thermosets including additives that are expected to function for the additives' intended use. For example, the optional components may comprise compounds that can be added to the composition to enhance application properties (for example surface tension modifiers or flow aids), reliability properties (for example adhesion promoters) the reaction rate, the selectivity of the reaction, and/or the catalyst lifetime.

For example, the curable composition of the present invention, containing one or more optional additives which are useful in the present invention composition for their intended use, may include, but not limited to, stabilizers, surfactants, flow modifiers, pigments or dyes, matting agents, degassing agents, flame retardants (e.g., inorganic flame retardants, halogenated flame retardants, and non-halogenated flame retardants such as phosphorus-containing materials), toughening agents, curing initiators, curing inhibitors, wetting agents, colorants or pigments, thermoplastics, processing aids, UV blocking compounds, fluorescent compounds, UV stabilizers, inert fillers, fibrous reinforcements, antioxidants, impact modifiers including thermoplastic particles, and mixtures thereof. The above list is intended to be exemplary and not limiting. The preferred additives for the, formulation of the present invention may be optimized by the skilled artisan.

The optional curing initiators useful in the curable composition may include those described in U.S. Pat. No. 5,164,464 and may include peroxides such as benzoyl peroxide and azo compounds such as 2-2′-azobisisobutyronitrile. The optional curing inhibitors may include phenolics such as hydroquinone or thiazines such as phenothiazine.

The concentration of the additional additives is generally between 0 wt % to about 90 wt %; preferably, between about 0.01 wt % to about 80 wt %; more preferably, between about 1 wt % to about 65 wt %; and most preferably, between about 10 wt % to about 50 wt % based on the weight of the total composition.

The process of preparing the curable composition of the present invention including admixing (I) at least one PFTS composition as described above; and, if desired, (II) any one or more of the optional additives as described above. For example, the preparation of the curable resin formulation of the present invention is achieved by blending, in known mixing equipment, the PFTS composition, and optionally any other desirable additives. Any of the above-mentioned optional additives, for example a curing catalyst, may be added to the composition during the mixing or prior to the mixing to form the composition.

All the compounds of the curable formulation are typically mixed and dispersed at a temperature enabling the preparation of an effective curable epoxy resin composition having the desired balance of properties for a particular application. For example, the temperature during the mixing of all components may be generally from about 0° C. to about 200° C. in one embodiment, and from about 20° C. to about 180° C. in another embodiment. Lower mixing temperatures help to minimize reaction of the PFTS compounds in the composition to maximize the pot life of the composition.

The preparation of the curable formulation of the present invention, and/or any of the steps thereof, may be a batch or a continuous process. The mixing equipment used in the process may be any vessel and ancillary equipment well known to those skilled in the art.

The PFTS composition can be cured alone, or in the presence of other additives as described above, to provide a PFTS composition having at least a portion of its terminal styrenic groups reacted to form a cured polymer or cured thermoset.

In one embodiment, curing of the PFTS composition may be accomplished (i) by heating the PFTS composition, (ii) by reacting the PFTS composition with a free radical initiator, or (iii) a combination of both process steps (i) and (ii).

In an illustrative embodiment, wherein the PFTS composition is used alone, the PFTS composition may be thermally cured at a predetermined temperature and for a predetermined period of time sufficient to cure the composition. For example, the process of curing of the PFTS composition may be carried out at a temperature generally from about 0° C. to about 200° C. in one embodiment; from about 20° C. to about 180° C. in another embodiment; and from about 40° C. to about 160° C. in still another embodiment

Generally, the curing time for the process of curing the curable composition may be chosen between about 1 minute to about 24 hours in one embodiment, between about 2 minutes to about 12 hours in another embodiment, and between about 4 minutes to about 8 hours in still another embodiment. Below a period of time of about 1 minute, the time may be too short to ensure sufficient reaction under conventional processing conditions; and above about 24 hours, the time may be too long to be practical or economical.

The process of curing the PFTS composition with one or more of the above additives can be carried as described above including for example thermally curing the composition at a predetermined temperature and for a predetermined period of time sufficient to cure the composition as described above.

The cured product (i.e. the cross-linked product made from the curable composition) of the present invention shows several improved properties over conventional cured resins. For example, the cured product of the present invention may advantageously have a high glass transition temperature (Tg).

For example, the cured product of the present invention exhibits a glass transition temperature generally between −50° C. and 250° C. in one embodiment, between about −25° C. and 225° C. in another embodiment, and between about 0° C. and 200° C. in still another embodiment. The Tg of the cured product can be measured by the thermomechanical analysis method described in ASTM E831-12.

The curable composition of the present invention may be used to manufacture a cured thermoset product such as adhesives, coatings, castings, laminates, prepregs and composites.

The PFTS formulations of the present invention used to prepare cured articles exhibit a combination and balance of advantageous properties including for example processability, Tg, mechanical performance, and solvent resistance.

### EXAMPLES

The following examples and comparative examples further illustrate the present invention in detail but are not to be construed to limit the scope thereof.

Various terms and designations used in the following examples are explained herein below:

“PFTS” stand for polyfunctional terminal styrenic.

“DVBMO” stands for divinylbenzene monoxide.

“2-MXEA” stands for 2-methoxyethylamine.

“BPO” stands for benzoyl peroxide.

The following standard analytical equipment and method were used in the Examples:

Thermomechanical analyses were done using a TA Instruments Thermomechanical Analyzer with the T_{g} taken as the temperature at the extrapolated onset point of the dimensional change curve using a temperature scan of 10° C./minute.

### Example 1

In this example, a difunctional terminal styrenic amine-epoxide coupled product, i.e. a curable PFTS composition, was prepared from DVBMO and 2-MXEA as follows: to a 50 mL round bottomed flask were added 20.0 g (0.15 eq.) DVBMO and 5.65 g (0.15 eq.) (2-MXEA). The resulting mixture was stirred with heating to 100° C. over a period of 4.25 hours, at which time no epoxide band at 880 cm⁻¹ was observed by infrared spectroscopy, to form the difunctional terminal styrenic amine-epoxide coupled product.

### Examples 2 and 3

In these examples, the difunctional terminal styrenic amine-epoxide coupled product prepared in Example 1 above was cured without a curing agent to form a thermoset (Example 2). In addition, the product of Example 1 was cured with benzoyl peroxide to form another thermoset (Example 3). The procedure used was as follows:

A sample of the terminal styrenic amine-epoxide coupled product with a curing agent was cured as follows: a 0.97 g. portion of the product of Example 1 was mixed at room temperature (about 25° C.) with 0.03 g (3 wt %) benzoyl peroxide. To an aluminum dish were separately added about 0.5 g each of Example 1 and the above mixture. The samples were cured in an air-recirculating oven for 45 minutes at 100° C. and 30 minutes each at 125° C., 150° C., and 200° C. The resulting cured compositions were analyzed by thermomechanical analysis (TMA) for glass transition temperature (T_{g}) and glassy and rubbery coefficients of thermal expansion (CTE_{g} and CTEᵣ, respectively) as shown in Table 1.

Another sample of the terminal styrenic amine-epoxide coupled product was cured as described above except without the benzoyl peroxide curing agent. The resultant cured composition was also analyzed by TMA and the results are described in Table 1.

TABLE 1
Cured Thermoset Properties

| | | T_{g} | CTE_{g} | CTEᵣ |
|---|---|---|---|---|
| Example | Initiator | (° C.) | (μm/m-° C.) | (μm/m-° C.) |
| Example 2 | none | 123 | 65.19 | 188.4 |
| Example 3 | BPO (3%) | 136 | 74.46 | 130.9 |

1. A curable polyfunctional terminal styrenic composition comprising a reaction product of: (a) at least one divinylarene monoxide compound, and (b) at least one polyfunctional epoxide coupling compound; wherein the reaction product comprises a curable polyfunctional terminal styrenic composition.

2. The curable composition of claim 1, comprising further (c) a reactive additive.

3. The curable composition of claim 2, wherein the reactive additive comprises styrene, divinylbenzene; butyl acrylate, methyl methacrylate, ethylene glycol diacrylate, trimethylolpropane triacrylate; and mixtures thereof.

4. The curable composition of claim 1, wherein the at least one divinylarene monoxide compound comprises divinylbenzene monoxide (DVBMO), divinylnaphthalene monoxide, divinylbiphenyl monoxide, divinyldiphenylether monoxide, or mixtures thereof.

5. The curable composition of claim 1, wherein the concentration of the at least one divinylarene monoxide compound comprises from about 0.01 to about 100 epoxide equivalents per epoxide coupling compound equivalents.

6. The curable composition of claim 1, wherein the at least one polyfunctional epoxide coupling compound comprises polyamine, polyamide, polyaminoamide, dicyandiamide, polyphenol, polymeric thiol, polycarboxylic acid and anhydride, or mixtures thereof.

7. A process for preparing a curable polyfunctional terminal styrenic composition comprising reacting: (a) at least one divinylarene monoxide compound, and (b at least one polyfunctional epoxide coupling compound under reaction conditions to form a reaction product comprising a curable polyfunctional terminal styrenic composition.

8. A curable polyfunctional terminal styrenic composition comprising:
(I) at least one compound comprising a reaction product of:
(a) at least one divinylarene monoxide compound, and
(b) at least one polyfunctional epoxide coupling compound, wherein the reaction product comprises a curable polyfunctional terminal styrenic composition; and
(II) at least one free radical initiator.

9. The curable composition of claim 8, wherein the concentration of the polyfunctional terminal styrenic composition comprises from about 80 weight percent to about 99.99 weight percent; and the concentration of the free radical initiator comprises from about 0.01 weight percent to about 20 weight percent.

10. The curable composition of claim 1 or claim 8, comprising further (III) at least one coupling catalyst.

11. The curable composition of claim 10, wherein the at least one coupling catalyst comprises an amine, a phosphine, a heterocyclic nitrogen, an ammonium, a phosphonium, an arsonium, a sulfonium compound, or mixtures thereof.

12. The curable composition of claim 10, wherein the concentration of the at least one coupling catalyst comprises from 0 weight percent to about 20 weight percent.

13. The curable composition of claim 1 or claim 8, including at least one reactive additive, a filler, a flexibilizing agent, a processing aide, a toughening agent, or a mixture thereof.

14. The curable composition of claim 13, wherein the reactive additive comprises styrene, divinylbenzene; butyl acrylate, methyl methacrylate, ethylene glycol diacrylate, trimethylolpropane triacrylate; and mixtures thereof.

15. A process for preparing a curable polyfunctional terminal styrenic composition comprising admixing:
(I) at least one compound comprising a reaction product of:
(a) at least one divinylarene monoxide compound, and
(b) at least one polyfunctional epoxide coupling compound, wherein the reaction product comprises a curable polyfunctional terminal styrenic composition; and
(II) at least one free radical initiator.

16. A process for preparing a thermoset comprising curing the curable composition of claim 1 or claim 8 with heat at a temperature of from about 0° C. to about 200° C.

17. A cured thermoset article prepared from the curable composition of claim 1 or claim 8.
